(19) United States
(12) Patent Application Publication
(10) Pub. No.: US 2002/0161488 A1
(43) Pub. Date: Oct. 31, 2002

(54) Assembly for control and/or monitoring of funtional members of an aircraft

(76) Inventors: Loic Yann Guillemin, Maisons Alfort (FR); Jean-Clair Pradier, Houilles (FR); Pierre Ballarini, Paris (FR); Jacques Etienne Emmanuel Barrois, Aulnay Sous Bois (FR)

Correspondence Address: LARSON & TAYLOR, PLC, 1199 NORTH FAIRFAX STREET, SUITE 900, ALEXANDRIA, VA, 22314, US

(21) Appl. No.: 09/768,187

(22) Filed: May 25, 2001

(30) Foreign Application Priority Data
Jan. 24, 2000 (FR) 0000860

(51) Int. Cl. G06F 17/00

(52) U.S. Cl. 701/3

(57) ABSTRACT

Assembly (10) for control and/or monitoring of functional members (32, 36, 40, 42, 46, 48, 54, 56) of an aircraft, of the type comprising at least two modules (30, 34, 38, 44, 50, 52) for control and/or monitoring of functional members and gateways for transferring data between said modules and at least one main data transport bus (14) of the aircraft. It comprises at least one secondary serial bus (16) allowing the transport of data according to the CAN protocol. Each control and/or monitoring module (30, 34, 38, 44, 50, 52) comprises at least one interface (70) for communication with at least one serial bus according to the CAN protocol, the control and/or monitoring modules (30, 34, 38, 44, 50, 52) being connected to the or to each secondary bus (16) across the or each communication interface (70). Said assembly furthermore comprises at least one communication gateway (18, 20) ensuring the transfer of data between the or each main bus (14) and the or each secondary bus (16).

The present invention relates to an assembly for control and/or monitoring of functional members of an aircraft, of the type comprising at least two modules for control and/or monitoring of functional members and means for transferring data between said modules and at least one main data transport bus of the aircraft.

In modern aircraft, it is known practice to interlink the modules for control and/or monitoring of functional members of the aircraft through one or more main buses of the aircraft. These buses are commonly buses which are specific to the field of aviation, and in particular buses using the distributed serial bus protocols such as ARINC 629, 1553 or DIGIBUS. Thus, by way of example, for the management of the movable elements of the landing gear of an aircraft, several control and/or monitoring modules are implemented, the latter each being linked to the main bus of the aircraft.

In particular, for the right and left landing gear, a specific control and/or monitoring module is implemented so as to ensure each of the following functions:

monitoring of the pressure of the tires of the aircraft,

measurement of the temperature of the braking members,

management and monitoring of the means for steering the wheels of the craft when the landing gear comprise movable steerable wheels,

management and monitoring of the system for braking the wheels, and

management and monitoring of the movable elements related to the landing gear, to the doors and to the thrust reversal systems.

Thus, just for the landing gear of the aircraft, twelve modules for control and/or monitoring of the functional members are linked to the main bus of the aircraft so as to receive or address data.

Each control and/or monitoring module comprises a calculator implementing a program adapted so as to ensure the control and/or monitoring function to which it is dedicated, as well as a communication interface adapted to the ARINC 629 protocol of the main bus allowing the exchange of data between the calculator and the main bus of the aircraft.

On account of the exclusively aeronautical use of ARINC 629 type buses, the cost of the components which ensure the management of the protocol in the communication interface of each module is relatively high. Indeed, the buses of this type are not very widespread, so ruling out a significant reduction in the cost of manufacturing the specifically dedicated components.

Thus, the assembly of modules for control and/or monitoring of functional members is rather expensive.

The aim of the invention is to propose an assembly for control and/or monitoring of functional members of an aircraft in which each control and/or monitoring module can communicate with a main data transport bus of the aircraft, but the overall cost of which is relatively low.

Accordingly, the subject of the invention is an assembly for control and/or monitoring of functional members of an aircraft, of the abovementioned type, characterized in that it comprises at least one secondary serial bus allowing the transport of data according to the CAN protocol, in that each control and/or monitoring module comprises at least one interface for communication with the secondary bus according to the CAN protocol, the control and/or monitoring modules being connected to the or to each secondary bus across the or each communication interface, and in that said assembly furthermore comprises at least one communication gateway ensuring the transfer of data between the or each main bus and the or each secondary bus.

According to particular embodiments, the control and/or monitoring assembly comprises one or more of the following characteristics:

it comprises a backplane card into which is integrated the or each secondary bus, and the backplane card and each control and/or monitoring module comprise complementary connectors for linking the module to the secondary bus;

each control and/or monitoring module is integrated onto a card adapted to be plugged in to the backplane card by way of said complementary connectors;

the or each communication gateway is adapted to ensure a conversion of the data from the CAN protocol to the ARINC 629 protocol of the main bus;

it comprises at least two secondary serial buses allowing the transport of data according to the CAN protocol, these two buses being mounted in parallel and ensuring the simultaneous transport of the same data between the control and/or monitoring modules.

The invention will be better understood on reading the description which follows, given merely by way of example and while referring to the single figure which is a diagrammatic view of a control and/or monitoring assembly according to the invention.

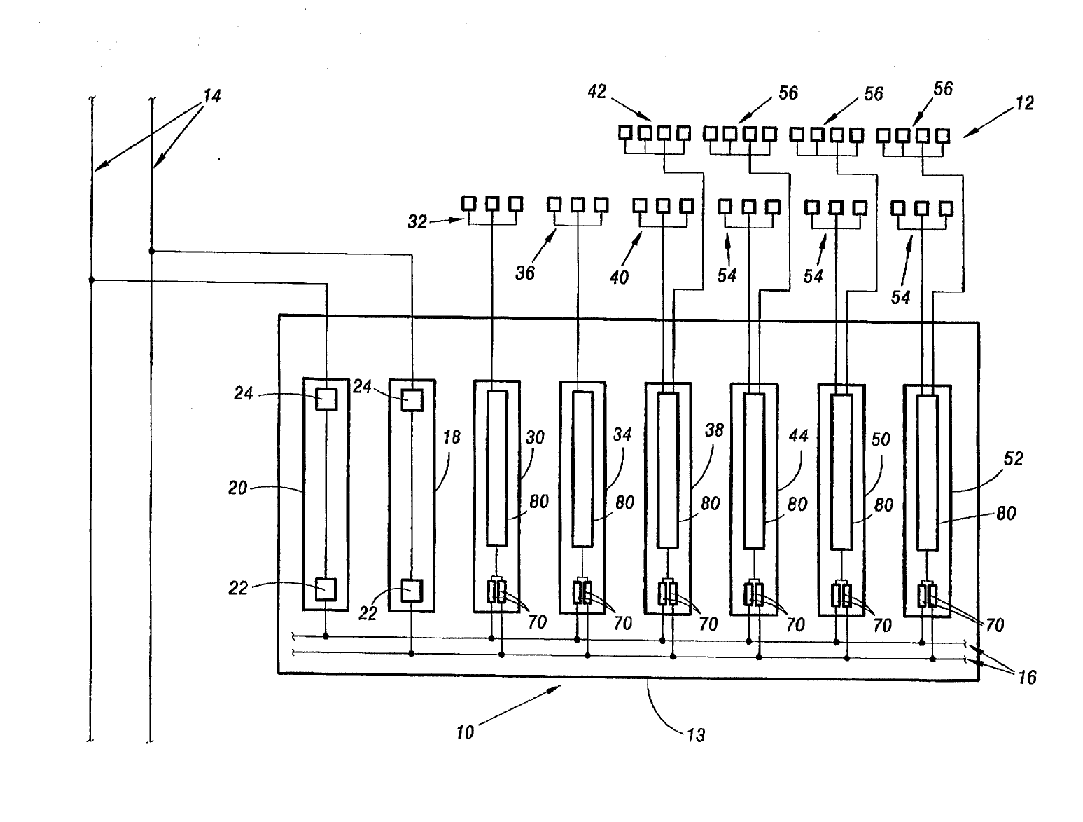

Represented in FIG. 1 is an assembly 10 for control and/or monitoring of functional members according to the invention. These functional members are designated by the general reference 12.

The assembly 10 constitutes a unit whose various elements are collected together in the same box or cabinet 13.

This unit is linked to two main data transport buses 14 of the aircraft. These buses are for example buses using the ARINC 629 protocol. The buses 14 are redundant and simultaneously ensure the transport of the same data increasing the transfer rate and also the reliability of the installation.

The unit 10 comprises two secondary buses 16. These buses are of serial type and are dedicated to the transfer of data according to the CAN protocol (CONTROLLER AREA NETWORK). This protocol is defined by the following documents:

CAN PROTOCOL SPECIFICATION VLO—Robert Bosch Company 1991 and 1992;

ISO 11519-1

Véhicules routiers—communications en série de données à basse vitesse—partie 1: Généralités et définitions, 1994 [road vehicles—low speed serial data communications—part 1: General considerations and definitions];

ISO 11519-2

Road vehicles low speed serial data communication: part 2: Low speed controller area network CAN, 1994;

ISO 11898

Road vehicles—interchange of digital information controller area network—CAN—for high speed communication ISO standard, 1993.

In accordance with the specifications of the CAN bus, each bus is formed of two shielded or unshielded conductors. These two buses 16 are redundant and simultaneously ensure the transport of the same data, thus increasing reliability.

Each secondary bus 16 is linked to a main bus 14 of the aircraft by a communication gateway 18 or 20. These communication gateways, integrated with the unit 10, ensure the transfer of data between a main bus 14 and the associated secondary bus 16. This transfer of data is ensured by modifying the shaping of the data, in accordance with the communication protocol used on each of the buses.

Accordingly, each gateway comprises a first CAN type interface 22 linked to the associated secondary bus 16. This interface is adapted for defining and receiving messages according to the CAN protocol used on the bus 16.

The first interface 22 is linked to a second ARINC 629 type interface 24. This interface is linked to one of the main buses 14. It ensures the definition and the reception of messages according to the ARINC 629 protocol of the main bus.

Thus, each gateway is adapted for performing a conversion between the protocols of the two buses.

The unit 10 furthermore comprises several modules for control and/or monitoring of the functional members 12. These modules are each linked to the secondary buses 16, so as to send and/or receive data.

By way of example, the module designated by the reference 30 is adapted for tracking the pressure of the tires of the landing gear of the aircraft. Accordingly, the module 30 is linked to pressure acquisition elements 32.

The module 34 is dedicated to the tracking of the temperature of the braking members of the landing gear. Accordingly, it is linked to temperature sensors 36.

The information gathered by the modules 30 and 34 is intended to be addressed to the cockpit of the aircraft through the bus 14, this information then being made available to the crew.

The module 38 is adapted for managing the orientation of the steerable wheels of the landing gear during the aircraft taxiing phases. Accordingly, the module 38 is linked to an assembly of position sensors 40, as well as to an assembly of actuators 42 acting on the steerable wheels of the landing gear as a function of the information received from the cockpit through the buses 14.

Modules 44, 50, 52 are adapted for managing other functions. These modules are also linked to assemblies of sensors 54 and to assemblies of actuators 56.

Each control and/or monitoring module comprises two communication interfaces 70 specifically adapted for implementing the CAN protocol. The modules 30, 34, 38, 44, 50 and 52 are thus linked to the secondary buses 16 by way of these interfaces 70.

Each module furthermore comprises an information processing unit 80 adapted for implementing a control and/or monitoring function dedicated to the relevant module. The information processing unit 80 is linked to the sensors and/or actuators associated with the module, as well as to the communication interfaces 70.

The unit 10 is advantageously formed of a cabinet or of a rack comprising a backplane card into which are integrated the pairs of conductors constituting the buses 16. This backplane card comprises for each control and/or monitoring module, a connector adapted for cooperating with a complementary connector carried by the associated module. These modules are advantageously made up of one or more cards which can be plugged onto the backplane card.

Preferably, the backplane card comprises a printed circuit on which tracks form the buses 16.

The control and/or monitoring assembly represented in FIG. 10 operates as follows.

When an item of control equipment of the aircraft addresses control data to one of the modules of the unit 10, these data are transmitted to the unit 10 via the main buses 14 by using the ARINC 629 protocol of the main bus. These data are converted by the gateways 18 and 20 into a format compatible with the CAN protocol. These data are then addressed to the destination control and/or monitoring module via the two secondary buses 16, using the CAN protocol.

Conversely, when data gathered by one of the control and/or monitoring modules need to be addressed to an element outside the aircraft, these data are addressed by the pertinent module to the gateways 18 and 20 through secondary buses 16, using the CAN protocol. The gateways ensure conversion of the message using the CAN protocol into a message using the ARINC 629 protocol of the main bus. The message is then addressed to the destination entity via the main buses 14.

It is understood that, regardless of the number of control and/or monitoring modules of the unit 10, only two communication interfaces using the ARINC 629 protocol of the main bus are necessary, each control and/or monitoring module comprising just one CAN type communication interface.

Insofar as the communication interfaces using the CAN protocol are of very low cost, the CAN type networks being widely available, the total cost of the unit 10 is low, despite the presence of the two gateways 18 and 20.

The presence of the two CAN buses designated by the reference 16 improves the reliability of the unit. However, a single bus could be used. In this case, a single gateway between the CAN and ARINC 629 protocols is implemented.

A control and/or monitoring assembly according to the invention can also be implemented in aircraft whose main transport buses use the 1553 and DIGIBUS protocols.

1. Assembly (10) for control and/or monitoring of functional members (32, 36, 40, 42, 46, 48, 54, 56) of an aircraft, of the type comprising at least two modules (30, 34, 38, 44, 50, 52) for control and/or monitoring of functional members and means for transferring data between said modules and at least one main data transport bus (14) of the aircraft, characterized in that it comprises at least one secondary serial bus (16) allowing the transport of data according to the CAN protocol, in that each control and/or monitoring module (30, 34, 38, 44, 50, 52) comprises at least one interface (70) for communication with the secondary bus (16) according to the CAN protocol, the control and/or monitoring modules (30, 34, 38, 44, 50, 52) being connected to the or to each secondary bus (16) across the or each communication interface (70), and in that said assembly furthermore comprises at least one communication gateway (18, 20) ensuring the transfer of data between the or each main bus (14) and the or each secondary bus (16).

2. Assembly according to claim 1, characterized in that it comprises a backplane card into which is integrated the or each secondary bus (16), and in that the backplane card and each control and/or monitoring module comprise complementary connectors for linking the module to the secondary bus (16).

3. Assembly according to claim 2, characterized in that each control and/or monitoring module is integrated onto a card adapted to be plugged in to the backplane card by way of said complementary connectors.

4. Assembly according to claim 1, characterized in that it comprises at least two secondary serial buses (16) allowing the transport of data according to the CAN protocol, these two buses being mounted in parallel and ensuring the simultaneous transport of the same data between the control and/or monitoring modules (30, 34, 38, 44, 50, 52).

5. Assembly according to any one of the preceding claims, characterized in that the or each communication gateway (18, 20) is adapted to ensure a conversion of the data from the CAN protocol to the ARINC 629 protocol of the main bus.
